(19) United States
(12) Patent Application Publication
(10) Pub. No.: US 2022/0269867 A1
(43) Pub. Date: Aug. 25, 2022

(54) METHOD FOR TRAINING IMAGE SEARCH MODEL AND METHOD FOR IMAGE SEARCH

(71) Applicant: BEIJING BAIDU NETCOM SCIENCE TECHNOLOGY CO., LTD., Beijing (CN)

(72) Inventors: Min YANG, Beijing (CN); Ruolin ZHU, Beijing (CN)

(21) Appl. No.: 17/742,994

(22) Filed: May 12, 2022

(30) Foreign Application Priority Data
Jul. 9, 2021 (CN) 202110778896.6

(51) Int. Cl. G06F 40/30; G06F 40/279; G06F 16/583; G06F 16/56

(52) U.S. Cl. CPC G06F 40/30; G06F 40/279; G06F 16/5846; G06F 16/56

(57) ABSTRACT

A method for training an image-text retrieval model includes: obtaining a sample text including a first language text and a second language text; and obtaining a target semantic translation network by training a semantic translation network of an image-text retrieval model based on the sample text, and generating a target image-text retrieval model based on the target semantic translation network.

### CROSS-REFERENCE TO RELATED APPLICATION

This application is based upon and claims priority to Chinese Patent Application No. 202110778896.6, filed on Jul. 9, 2021, the entire content of which are incorporated herein by reference.

### TECHNICAL FIELD

The disclosure relates to the field of computer technology, especially the field of artificial intelligence, in particular to computer vision and deep learning technology, which can be applied to image search scenes.

### BACKGROUND

Retrieval technology is applied in all aspects of daily life, which can be roughly divided into three major directions. Firstly, the direction is image/video retrieval, such as taking photos for retrieval of the same product or retrieval of the similar short videos. Secondly, the direction is text search, where keywords to be searched are input into a search engine, to retrieve the desired text information. In addition, the requirements for using text to search for corresponding pictures or videos is also increasing. At this time, the type of input information is different from the type of obtained information, which can be called “cross-modal” retrieval.

### SUMMARY

According to a first aspect of the disclosure, a method for training a image-text retrieval model is provided. The method includes: obtaining a sample text including a first language text and a second language text; and obtaining a target semantic translation network by training a semantic translation network of an image-text retrieval model based on the sample text, and generating a target image-text retrieval model based on the target semantic translation network. The target semantic translation network is configured to align semantics of the sample text with semantics of a training text in a target language, the training text is configured for training the image-text retrieval model.

According to a second aspect of the disclosure, a method for searching an image is provided. The method includes: obtaining a search text, the search text is one of a Chinese text, an English text, or a Chinese-English mixed text; and inputting the search text into a target image and text search model, and outputting by the target image-text retrieval model a target search image corresponding to the search text.

According to a third aspect of the disclosure, an electronic device is provided. The electronic device includes: a processor and a memory stored with instructions executable by the processor, and when the instructions are executed by the at least one processor, the method for training an image-text retrieval model according to the first aspect of the disclosure is implemented.

It should be understood that the content described in this section is not intended to identify key or important features of the embodiments of the disclosure, nor is it intended to limit the scope of the disclosure. Additional features of the disclosure will be easily understood based on the following description.

### BRIEF DESCRIPTION OF THE DRAWINGS

The drawings are used to better understand the solution and do not constitute a limitation to the disclosure.

FIG. 1 is a schematic diagram of a first embodiment of the disclosure.

FIG. 2 is a schematic diagram of a second embodiment of the disclosure.

FIG. 3 is a schematic diagram of a third embodiment of the disclosure.

FIG. 4 is a schematic diagram of a fourth embodiment of the disclosure.

FIG. 5 is a schematic diagram of a process of obtaining a third feature vector.

FIG. 6 is a schematic diagram of a fifth embodiment of the disclosure.

FIG. 7 is a schematic diagram of a target search image.

FIG. 8 is another schematic diagram of a target search image.

FIG. 9 is a block diagram of an apparatus for training an image search model for implementing a method for training an image search model according to an embodiment of the disclosure.

FIG. 10 is a block diagram of an apparatus for training an image search model for implementing a method for training an image search model according to an embodiment of the disclosure.

FIG. 11 is a block diagram of an image search apparatus for implementing a method for searching an image according to an embodiment of the disclosure.

FIG. 12 is a block diagram of an electronic device used to implement a method for training an image search model and a method for searching an image according to an embodiment of the disclosure.

### DETAILED DESCRIPTION

The following describes the exemplary embodiments of the disclosure with reference to the accompanying drawings, which includes various details of the embodiments of the disclosure to facilitate understanding, which shall be considered exemplary. For clarity and conciseness, descriptions of well-known functions and structures are omitted in the following description.

In the related art, for the cross-modal image search methods, technical problems such as excessive strict constraints to the search text, low search efficiency and poor reliability may occur. Therefore, how to improve the effectiveness and reliability of the process of training the image search model is one of the important research directions. At the same time, there is an urgent need to improve the effectiveness of cross-modal image-text search.

The following briefly describes the technical fields involved in the solution of the disclosure.

The content of computer technology is very extensive, which can be roughly divided into computer system technology, computer device technology, computer component technology, computer assembly technology and other aspects. Computer technology includes: basic principles of operation methods and arithmetic unit design, an instruction system, central processing unit (CPU) design, pipeline principle and its application in the CPU design, a storage system, a bus, and input and output.

Artificial intelligence (AI) is a discipline that allow computers to simulate certain human thinking processes and intelligent behaviors (such as learning, reasoning, thinking and planning), which has both hardware-level technology and software-level technology. AI hardware technology generally includes: computer vision technology, speech recognition technology, natural language processing technology and its learning/deep learning, big data processing technology, knowledge graph technology and other aspects.

Computer vision is a science that studies how to make machines “see”, it further refers to machine vision by using such as cameras and computers instead of human eyes to identify, track, and measure an object, and performing further graphic processing, so that the image can become more suitable for the human eye to observe or for transmitting to the instrument for detection after being processed by the computers. As a scientific discipline, computer vision studies related theories and technologies, and tries to build AI systems that can obtain “information” from images or multi-dimensional data. The information here is defined by Shannon that can be used to help make a “decision”. Because perception can be viewed as the extraction of information from sensory signals, computer vision can also be viewed as the science that studies how to make AI systems “perceive” the images or multidimensional data.

Deep Learning (DL) is a new research direction in the field of Machine Learning (ML), and it is introduced into ML to make it closer to the original goal, i.e., artificial intelligence. The DL learns the intrinsic laws and representation levels of sample data, and the information obtained during the learning process is of great help in the interpretation of data such as text, images and sounds. Its ultimate goal is to enable machines to have the ability to analyze and learn like humans, and to recognize data such as words, images and sounds. The DL is a complex machine learning algorithm that has achieved effect in voice and image recognition far exceeding the related art.

The following describes a method for training an image search model and a method for searching an image according to the embodiments of the disclosure with reference to the accompanying drawings.

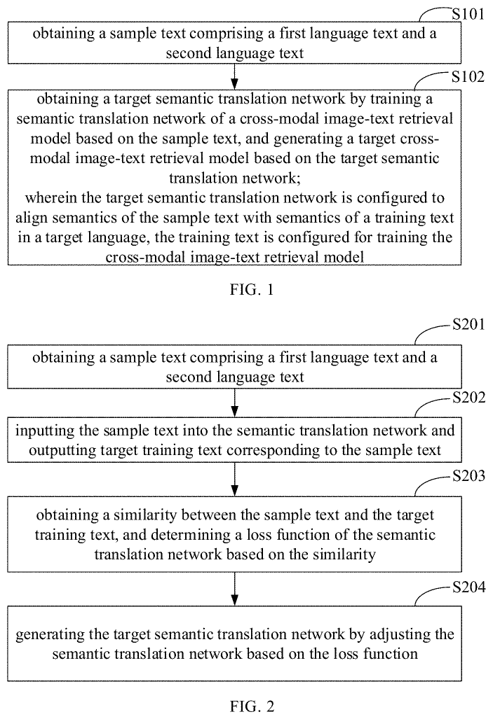

FIG. 1 is a schematic diagram of a first embodiment of the disclosure. It should be noted that the execution body of the method for training an image search model in this embodiment is an apparatus for training the image search model, and the apparatus for training the image search model may be a hardware device, or software in the hardware device. The hardware devices are, for example, terminal devices and servers.

As illustrated in FIG. 1, the method for training the image search model according to the embodiments includes the following steps.

In S101, a sample text including a first language text and a second language text is obtained. The first language text and the second language text can be any two texts in different languages. For example, the first language text may be in Chinese, and the second language text may be in English.

In S102, a target semantic translation network is obtained by training a semantic translation network of a cross-modal image-text retrieval model based on the sample text, and a target cross-modal image-text retrieval model is generated based on the target semantic translation network. The target semantic translation network is configured to align semantics of the sample text with semantics of a training text in a target language, the training text is configured for training the cross-modal image-text retrieval model.

The cross-modal image-text retrieval model includes the semantic translation network and an image processing network. The target cross-modal image-text retrieval model includes the target semantic translation network and an image processing network.

It should be noted that the cross-modal image-text retrieval model can adopt a Compression Learning by In-Parallel Pruning (CLIP) model, which is a pre-training model trained based on massive data. In this case, the semantic translation network can adopt a transformer, and the image processing network can adopt a vision transformer (VIT). Therefore, the CLIP model can be regarded as a transformer model obtained by large-scale text supervision training. In this way, the label of each image processed by the cross-modal image-text retrieval model is no longer a noun, but a sentence. Therefore, images that used to be forcibly divided into the same class are labeled with an “infinitely fine granularity”.

For example, the label of an image is “Samoy”, and in the above pairing example, the nuances can be learned among the images of the “Samoy” locating in different environments and doing different things, such as “Samoy is running in the snow”.

It can be seen that the CLIP model has amazing effects and outstanding performances in various downstream tasks. However, based on the characteristics of the CLIP model itself, the CLIP model cannot be directly applied to the cross-modal retrieval for Chinese texts and images. The method for training the image search model in the disclosure can use multi-language sample texts to train the semantic translation network of the cross-modal image-text retrieval model, so as to obtain the target semantic translation network, and generate the target cross-modal image-text retrieval model based on the target semantic translation network, which improves the applicability of the CLIP model.

According to the method for training the image search model in the embodiments of the disclosure, multi-language sample texts are obtained. The target semantic translation network is obtained by training the semantic translation network of the cross-modal image-text retrieval model based on the sample text. The target cross-modal image-text retrieval model is obtained based on the target semantic translation network. Therefore, the disclosure can maintain rich and accurate feature representation of the cross-modal image-text retrieval model trained based on large-scale data, and semantic alignment is achieved without losing mobility at the same time, which realizes cross-modal retrieval from a text in any language to an image, and improves the efficiency and reliability of the process of training the image search model.

FIG. 2 is a schematic diagram of a second embodiment of the disclosure.

As illustrated in FIG. 2, the method for training the image search model according to the embodiments includes the following steps S201-S204.

In S201, a sample text including a first language text and a second language text is obtained.

This step S201 is the same as the step S101 in the previous embodiment, and will not be repeated here.

In the previous embodiment, the step S102 of obtaining the target semantic translation network by training the semantic translation network of the cross-modal image-text retrieval model based on the sample text includes steps S202 to S204.

In S202, the sample text is input into the semantic translation network and target training text corresponding to the sample text is output.

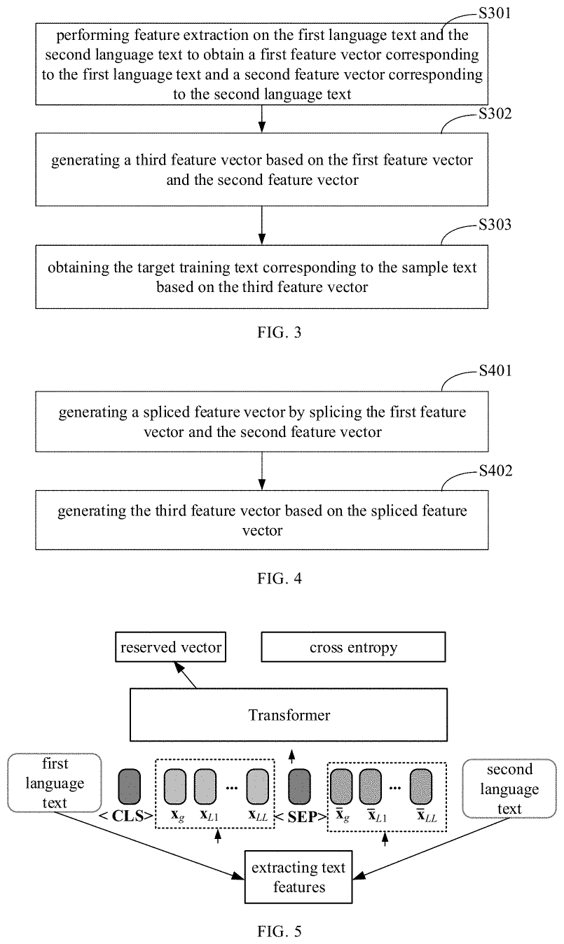

In a possible implementation, as illustrated in FIG. 3, on the basis of the above-described embodiments, the step S202 of inputting the sample text into the semantic translation network and outputting target training text corresponding to the sample text includes the following steps at S301-S303.

In S301, feature extraction is performed on the first language text and the second language text to obtain a first feature vector corresponding to the first language text and a second feature vector corresponding to the second language text.

In the embodiments of the disclosure, the first language text and the second language text can be processed through the semantic translation network, to obtain feature representation outputs of both the first language text and the second language text, for example, an English sequence (Es) and a Chinese sequence (Cs).

In S302, a third feature vector is generated based on the first feature vector and the second feature vector.

In a possible implementation, as illustrated in FIG. 4, on the basis of the above-described embodiments, the step S302 of generating the third feature vector based on the first feature vector and the second feature vector includes the following steps at S401-S402.

In S401, a spliced feature vector is generated by splicing the first feature vector and the second feature vector.

In the embodiment of the disclosure, the first feature vector and the second feature vector may be connected through a separator to generate the spliced feature vector.

For example, the first feature vector Es and the second feature vector Cs can be connected by a separator [Sep] to generate the spliced feature vector.

In S402, the third feature vector is generated based on the spliced feature vector.

In the embodiments of the disclosure, a reserved vector may be added before the spliced feature vector to form the third feature vector.

For example, as illustrated in FIG. 5, after extracting text features from the first language text and the second language text respectively, the first language text and the second language text are connected by the separator [Sep] to generate the spliced feature vector Es[Sep]Cs. Further, the reserved vector [CLS] is added before the spliced feature vector to obtain the third feature vector [CLS]Es[Sep]Cs.

In S303, the target training text corresponding to the sample text is obtained based on the third feature vector.

In the embodiments of the disclosure, a similarity between the third feature vector and a fourth feature vector of a candidate training text can be determined, and the candidate training text corresponding to the fourth feature vector with the highest similarity can be thus determined as the target training text.

In S203, a similarity between the sample text and the target training text is obtained, and a loss function of the semantic translation network is determined based on the similarity.

In the embodiments of the disclosure, the similarity between the sample text and the target training text can be obtained, and then a similarity difference between the sample text and the target training text can be obtained, and then based on the similarity difference, a mapping relationship between a preset similarity difference and a loss function adjustment strategy is queried, so as to determine the loss function of the semantic translation network.

In S204, the target semantic translation network is generated by adjusting the semantic translation network based on the loss function.

In the embodiments of the disclosure, parameters of the semantic translation network can be adjusted based on the loss function, and the next sample text is continued to train the semantic translation network until the training is completed, and the target semantic translation network is generated.

It should be noted that the conditions for completing the training are not set in the disclosure, and can be selected according to the actual situation. For example, the condition can be set to the similarity difference between the sample text and the target training text being less than a similarity threshold.

According to the method for training the image search model in the embodiments of the disclosure, the sample text can be input into the semantic translation network and the target training text corresponding to the sample text is output. The similarity between the sample text and the target training text is obtained, and the loss function of the semantic translation network is determined based on the similarity, and then the target semantic translation network is generated by adjusting the semantic translation network based on the loss function. In this way, the target semantic translation network is generated, which can be well adapted to the downstream model. The training process is simple, and the original parameters may not be destroyed, which further improves the efficiency and reliability of the process of training the image search model.

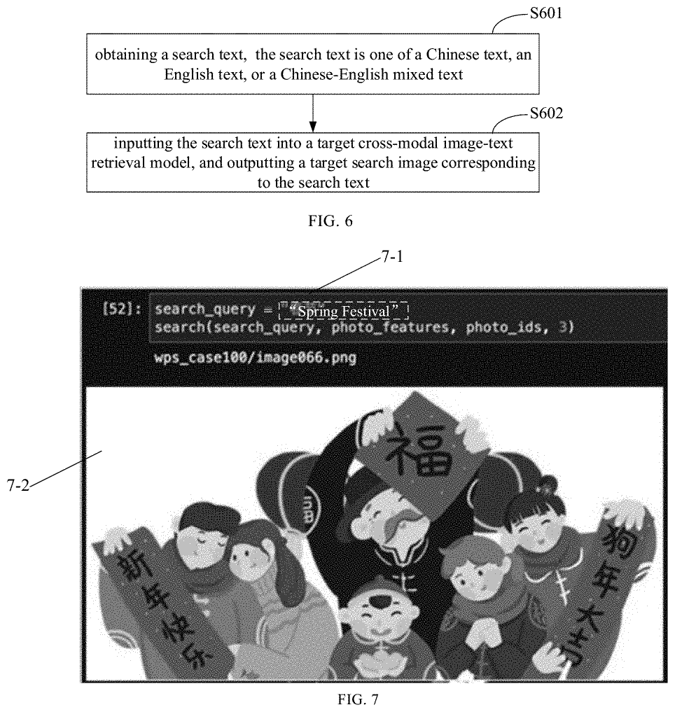

FIG. 6 is a schematic diagram of a fifth embodiment of the disclosure. It should be noted that the execution body of the method for searching an image in this embodiment is an image search apparatus, and the image search apparatus may be a hardware device or software in the hardware device. The hardware devices are, for example, terminal devices and servers.

As illustrated in FIG. 6, the method for searching an image according to the embodiments includes the following steps at S601-S602.

In S601, a search text is obtained, in which the search text is one of a Chinese text, an English text, or a Chinese-English mixed text.

For example, the search text may be one of “ [symbol] (a Chinese phrase, which means spring festival)”, “spring festival”, or “ [symbol] spring festival”.

It should be noted that, in the disclosure, the number of phrases in the search text is not limited, and the phrases may be any phrase, or a combination of at least two phrases. For example, the search text can be “spring festival”, or “City, House”.

In S602, the search text is input into a target cross-modal image-text retrieval model, and a target search image corresponding to the search text is output.

For example, as illustrated in FIG. 7, a search text 7-1 (i.e., spring festival) is input into the target cross-modal image-text retrieval model, and a target search image 7-2 corresponding to the search text is output.

For another example, as illustrated in FIG. 8, a search text 8-1 (i.e., city, house) is input into the target cross-modal image-text retrieval model, and a target search image 8-2 corresponding to the search text is output.

According to the method for training the image search model in the embodiments of the disclosure, the search text is obtained, the search text is then input into the target cross-modal image-text retrieval model, and the target search image corresponding to the search text is output, so as to realize cross-modal image search based on text, the language of the search text is no longer limited, which improves the efficiency and adaptability of the image search process, and improves the user experience.

In the technical solution of the disclosure, the acquisition, storage and application of the involved user personal information all comply with the provisions of relevant laws and regulations, and do not violate public order and good customs.

Corresponding to the method for training the image search model according to the above-mentioned embodiments, the embodiments of the disclosure also provides an apparatus for training an image search model. Since the apparatus for training the image search model according to the embodiments of the disclosure corresponds to the method for training the image search model according to several embodiments of the disclosure, the implementation of the method for training the image search model is also applicable to the apparatus for training an image search model according to the embodiments, which will not be described in detail in this embodiment.

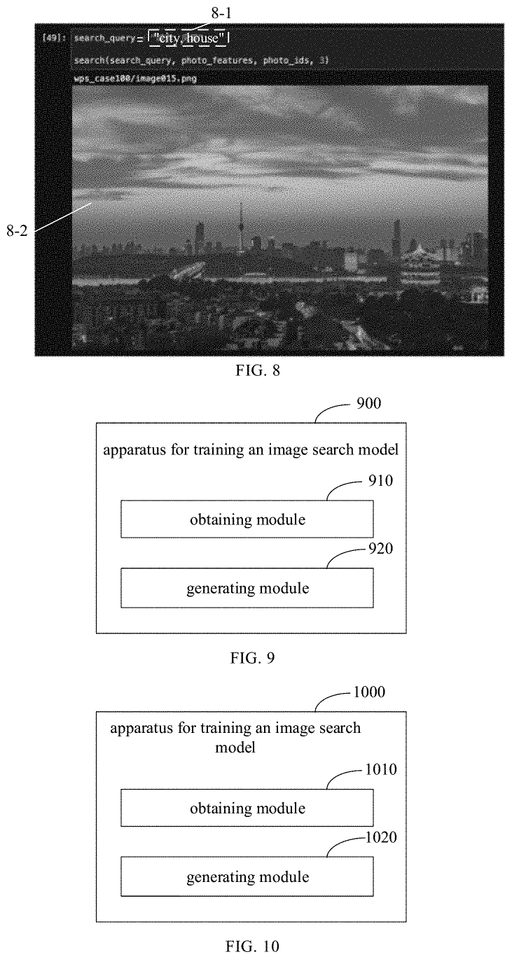

FIG. 9 is a structural schematic diagram of an apparatus for training an image search model according to an embodiment of the disclosure.

As illustrated in FIG. 9, the apparatus 900 for training an image search model includes: an obtaining module 910 and a generating module 920.

The obtaining module 910 is configured to obtain a sample text including a first language text and a second language text.

The generating module 920 is configured to obtain a target semantic translation network by training a semantic translation network of a cross-modal image-text retrieval model based on the sample text, and generate a target cross-modal image-text retrieval model based on the target semantic translation network.

The target semantic translation network is configured to align semantics of the sample text with semantics of a target language training text, and the target language training text is configured for training the cross-modal image-text retrieval model.

FIG. 10 is another schematic diagram of an apparatus for training an image search model according to an embodiment of the disclosure.

As illustrated in FIG. 10, the apparatus 1000 for training an image search model includes: an obtaining module 1010 and a generating module 1020.

The generating module 1020 is configured to: input the sample text into the semantic translation network and output target training text corresponding to the sample text; obtain a similarity between the sample text and the target training text, and determine a loss function of the semantic translation network based on the similarity; and generate the target semantic translation network by adjusting the semantic translation network based on the loss function.

Moreover, the generating module 1020 is configured to: perform feature extraction on the first language text and the second language text to obtain a first feature vector corresponding to the first language text and a second feature vector corresponding to the second language text; generate a third feature vector based on the first feature vector and the second feature vector; and obtain the target training text corresponding to the sample text based on the third feature vector.

Further, the generating module 1020 is configured to: obtain a similarity between the third feature vector and fourth feature vectors corresponding to candidate training texts, and determine the candidate training text corresponding to the fourth feature vector with the highest similarity as the target training text.

The generating module 1020 is further configured to: generate a spliced feature vector by splicing the first feature vector and the second feature vector; and generate the third feature vector based on the spliced feature vector.

Also, the generating module 1020 is further configured to: generate the spliced feature vector by connecting the first feature vector and the second feature vector through a separator.

In addition, the generating module 1020 is further configured to: obtain the third feature vector by adding a reserved vector before the spliced feature vector.

It should be noted that the obtaining module 1010 and the obtaining module 910 have the same function and structure.

According to the apparatus for training an image search model in the embodiments of the disclosure, the sample texts in multiple languages are obtained. The target semantic translation network is obtained by training the semantic translation network of the cross-modal image-text retrieval model based on the sample texts. The target cross-modal image-text retrieval model is generated based on the target semantic translation network. Therefore, the disclosure can maintain rich and accurate feature representation of the cross-modal image-text retrieval model trained based on large-scale data, and semantic alignment is done without losing mobility at the same time, which realizes cross-modal retrieval from a text in any language to an image, and improves the efficiency and reliability of the process of training the image search model.

Corresponding to the method for searching an image according to the above embodiments, the embodiments of the disclosure further provides an image search apparatus. Since the image search apparatus according to the embodiments of the disclosure corresponds to the method for searching an image according to the embodiments of the disclosure, the implementation of the method for searching an image is also applicable to the image search apparatus according to the embodiments, which will not be described in detail in this embodiments.

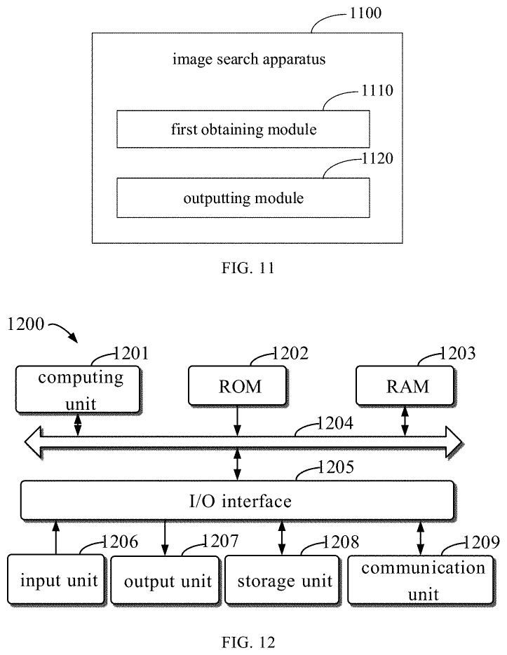

FIG. 11 is a schematic diagram of an image search apparatus according to an embodiment of the disclosure.

As illustrated in FIG. 11, the image search apparatus 1100 includes: a first obtaining module 1110 and an outputting module 1120.

The first obtaining module 1110 is configured to obtain a search text, the search text is one of a Chinese text, an English text, or a Chinese-English mixed text.

The outputting module 1120 is configured to input the search text into a target cross-modal image and text search model, and output a target search image corresponding to the search text.

According to the method for training an image search model in the embodiments of the disclosure, the search text is obtained and input into the target cross-modal image-text retrieval model, and the target search image corresponding to the search text is output. Therefore, the text-based cross-modal image retrieval can be achieved, the language of the search text is no longer limited, which improves the efficiency and adaptability of the image search process, and improves the user experience.

According to the embodiments of the disclosure, the disclosure also provides an electronic device, a readable storage medium and a computer program product.

FIG. 12 is a block diagram of an example electronic device 1200 used to implement the embodiments of the disclosure. Electronic devices are intended to represent various forms of digital computers, such as laptop computers, desktop computers, workbenches, personal digital assistants, servers, blade servers, mainframe computers, and other suitable computers. Electronic devices may also represent various forms of mobile devices, such as personal digital processing, cellular phones, smart phones, wearable devices, and other similar computing devices. The components shown here, their connections and relations, and their functions are merely examples, and are not intended to limit the implementation of the disclosure described and/or required herein.

As illustrated in FIG. 12, the device 1200 includes a computing unit 1201 performing various appropriate actions and processes based on computer programs stored in a read-only memory (ROM) 1202 or computer programs loaded from the storage unit 1208 to a random access memory (RAM) 1203. In the RAM 1203, various programs and data required for the operation of the device 1200 are stored. The computing unit 1201, the ROM 1202, and the RAM 1203 are connected to each other through a bus 1204. An input/output (I/O) interface 1205 is also connected to the bus 1204.

Components in the device 1200 are connected to the I/O interface 1205, including: an inputting unit 1206, such as a keyboard, a mouse; an outputting unit 1207, such as various types of displays, speakers; a storage unit 1208, such as a disk, an optical disk; and a communication unit 1209, such as network cards, modems, and wireless communication transceivers. The communication unit 1209 allows the device 1200 to exchange information/data with other devices through a computer network such as the Internet and/or various telecommunication networks.

The computing unit 1201 may be various general-purpose and/or dedicated processing components with processing and computing capabilities. Some examples of computing unit 1201 include, but are not limited to, a central processing unit (CPU), a graphics processing unit (GPU), various dedicated AI computing chips, various computing units that run machine learning model algorithms, and a digital signal processor (DSP), and any appropriate processor, controller and microcontroller. The computing unit 1201 executes the various methods and processes described above, such as the method for training an image search model or a method for searching an image. For example, in some embodiments, the method may be implemented as a computer software program, which is tangibly contained in a machine-readable medium, such as the storage unit 1208. In some embodiments, part or all of the computer program may be loaded and/or installed on the device 1200 via the ROM 1202 and/or the communication unit 1209. When the computer program is loaded on the RAM 1203 and executed by the computing unit 1201, one or more steps of the method described above may be executed. Alternatively, in other embodiments, the computing unit 1201 may be configured to perform the method in any other suitable manner (for example, by means of firmware).

Various implementations of the systems and techniques described above may be implemented by a digital electronic circuit system, an integrated circuit system, Field Programmable Gate Arrays (FPGAs), Application Specific Integrated Circuits (ASICs), Application Specific Standard Products (ASSPs), System on Chip (SOCs), Load programmable logic devices (CPLDs), computer hardware, firmware, software, and/or a combination thereof. These various embodiments may be implemented in one or more computer programs, the one or more computer programs may be executed and/or interpreted on a programmable system including at least one programmable processor, which may be a dedicated or general programmable processor for receiving data and instructions from the storage system, at least one input device and at least one output device, and transmitting the data and instructions to the storage system, the at least one input device and the at least one output device.

The program code configured to implement the method of the disclosure may be written in any combination of one or more programming languages. These program codes may be provided to the processors or controllers of general-purpose computers, dedicated computers, or other programmable data processing devices, so that the program codes, when executed by the processors or controllers, enable the functions/operations specified in the flowchart and/or block diagram to be implemented. The program code may be executed entirely on the machine, partly executed on the machine, partly executed on the machine and partly executed on the remote machine as an independent software package, or entirely executed on the remote machine or server.

In the context of the disclosure, a machine-readable medium may be a tangible medium that may contain or store a program for use by or in connection with an instruction execution system, apparatus, or device. The machine-readable medium may be a machine-readable signal medium or a machine-readable storage medium. A machine-readable medium may include, but is not limited to, an electronic, magnetic, optical, electromagnetic, infrared, or semiconductor system, apparatus, or device, or any suitable combination of the foregoing. More specific examples of machine-readable storage media include electrical connections based on one or more wires, portable computer disks, hard disks, random access memories (RAM), read-only memories (ROM), electrically programmable read-only-memory (EPROM), flash memory, fiber optics, compact disc read-only memories (CD-ROM), optical storage devices, magnetic storage devices, or any suitable combination of the foregoing.

In order to provide interaction with a user, the systems and techniques described herein may be implemented on a computer having a display device (e.g., a Cathode Ray Tube (CRT) or a Liquid Crystal Display (LCD) monitor for displaying information to a user); and a keyboard and pointing device (such as a mouse or trackball) through which the user can provide input to the computer. Other kinds of devices may also be used to provide interaction with the user. For example, the feedback provided to the user may be any form of sensory feedback (e.g., visual feedback, auditory feedback, or haptic feedback), and the input from the user may be received in any form (including acoustic input, voice input, or tactile input).

The systems and technologies described herein can be implemented in a computing system that includes background components (for example, a data server), or a computing system that includes middleware components (for example, an application server), or a computing system that includes front-end components (for example, a user computer with a graphical user interface or a web browser, through which the user can interact with the implementation of the systems and technologies described herein), or include such background components, intermediate computing components, or any combination of front-end components. The components of the system may be interconnected by any form or medium of digital data communication (e.g., a communication network). Examples of communication networks include: local area network (LAN), wide area network (WAN), the Internet and a Block-chain network.

The computer system may include a client and a server. The client and server are generally remote from each other and interacting through a communication network. The client-server relation is generated by computer programs running on the respective computers and having a client-server relation with each other. The server can be a cloud server, a server of a distributed system, or a server combined with a block-chain.

The disclosure also provides a computer program product including computer programs, when the computer programs are executed by a processor, the above method for training an image search model or a method for searching an image is implemented.

It should be understood that the various forms of processes shown above can be used to reorder, add or delete steps. For example, the steps described in the disclosure could be performed in parallel, sequentially, or in a different order, as long as the desired result of the technical solution disclosed in the disclosure is achieved, which is not limited herein. The above specific embodiments do not constitute a limitation on the protection scope of the disclosure.

What is claimed is:

1. A method for training an image-text retrieval model, comprising:
obtaining a sample text comprising a first language text and a second language text;
obtaining a target semantic translation network by training a semantic translation network of an image-text retrieval model based on the sample text, and generating a target image-text retrieval model based on the target semantic translation network;
wherein the target semantic translation network is configured to align semantics of the sample text with semantics of a training text in a target language, the training text is configured for training the image-text retrieval model.

2. The method of claim 1, wherein obtaining the target semantic translation network by training the semantic translation network of the image-text retrieval model based on the sample text, comprises:
inputting the sample text into the semantic translation network and outputting target training text corresponding to the sample text;
obtaining a similarity difference between the sample text and the target training text, and determining a loss function of the semantic translation network based on the similarity difference; and
generating the target semantic translation network by adjusting the semantic translation network based on the loss function.

3. The method of claim 2, wherein inputting the sample text into the semantic translation network and outputting the target training text corresponding to the sample text comprises:
performing feature extraction on the first language text and the second language text to obtain a first feature vector corresponding to the first language text and a second feature vector corresponding to the second language text;
generating a third feature vector based on the first feature vector and the second feature vector; and
obtaining the target training text corresponding to the sample text based on the third feature vector.

4. The method of claim 3, wherein obtaining the target training text corresponding to the sample text comprises:
obtaining a similarity between the third feature vector and each of fourth feature vectors corresponding to candidate training texts, and determining a candidate training text corresponding to the fourth feature vector with the highest similarity as the target training text.

5. The method of claim 3, wherein generating the third feature vector comprises:
generating a spliced feature vector by splicing the first feature vector and the second feature vector; and
generating the third feature vector based on the spliced feature vector.

6. The method of claim 5, wherein generating the spliced feature vector by splicing the first feature vector and the second feature vector comprises:
generating the spliced feature vector by connecting the first feature vector and the second feature vector through a separator.

7. The method of claim 5, wherein generating the third feature vector comprises:
obtaining the third feature vector by adding a reserved vector before the spliced feature vector.

8. A method for searching an image, comprising:
obtaining a search text, wherein the search text is one of a Chinese text, an English text, and a Chinese-English mixed text; and
inputting the search text into a target image-text retrieval model, and outputting by the target image-text retrieval model a target search image corresponding to the search text.

9. An electronic device, comprising:
a processor; and
a memory configured to store with instructions executable by the processor;
wherein the processor is configured to:
obtain a sample text comprising a first language text and a second language text;
obtain a target semantic translation network by training a semantic translation network of a image-text retrieval model based on the sample text, and generate a target image-text retrieval model based on the target semantic translation network;
wherein the target semantic translation network is configured to align semantics of the sample text with semantics of a training text in a target language, the training text is configured for training the image-text retrieval model.

10. The electronic device of claim 9, wherein the processor is further configured to:
input the sample text into the semantic translation network and output target training text corresponding to the sample text;
obtain a similarity difference between the sample text and the target training text, and determine a loss function of the semantic translation network based on the similarity difference; and
generate the target semantic translation network by adjusting the semantic translation network based on the loss function.

11. The electronic device of claim 10, wherein the processor is further configured to:
perform feature extraction on the first language text and the second language text to obtain a first feature vector corresponding to the first language text and a second feature vector corresponding to the second language text;
generate a third feature vector based on the first feature vector and the second feature vector; and
obtain the target training text corresponding to the sample text based on the third feature vector.

12. The electronic device of claim 11, wherein the processor is further configured to:
obtain a similarity between the third feature vector and each of fourth feature vectors corresponding to candidate training texts, and determine a candidate training text corresponding to the fourth feature vector with the highest similarity as the target training text.

13. The electronic device of claim 11, wherein the processor is further configured to:
generate a spliced feature vector by splicing the first feature vector and the second feature vector; and
generate the third feature vector based on the spliced feature vector.

14. The electronic device of claim 13, wherein the processor is further configured to:
generate the spliced feature vector by connecting the first feature vector and the second feature vector through a separator.

15. The electronic device of claim 13, wherein the processor is further configured to:
obtain the third feature vector by adding a reserved vector before the spliced feature vector.

16. The electronic device of claim 9, wherein the processor is further configured to input a search text into the target image-text retrieval model and output a target search image corresponding to the search text, in which the search text is one of a Chinese text, an English text, and a Chinese-English mixed text.
